(19) United States
(12) Patent Application Publication
(10) Pub. No.: US 2019/0112868 A1
(43) Pub. Date: Apr. 18, 2019

(54) Refrigerated Railcar Door Sealing Gasket

(71) Applicant: Central Sales & Services, Inc., Waverly, TN (US)

(72) Inventor: Ralph A. Deaver, Dickson, TN (US)

(73) Assignee: Central Sales & Services, Inc., Waverly, TN (US)

(21) Appl. No.: 15/783,646

(22) Filed: Oct. 13, 2017

(51) Int. Cl. E06B 7/23; B61D 19/00

(52) U.S. Cl. CPC E06B 7/2305; E06B 7/2314; B61D 19/001

(57) ABSTRACT

A railcar door sealing gasket includes a bulb body secured along one of a door jamb stop surface or a door perimeter stop surface. The bulb body is integrally formed by a tubular sleeve internally separated with a wall into interior and exterior elongate channels. The separating wall is formed with pair of planar walls extending at an angle with respect to each other from the sleeve to a crest towards the interior channel. When the gasket is compressed between the door and jamb stop surfaces, the sleeve portion adjacent the exterior channel is forced against and forms a seal along one of the jamb stop surface or door stop surface, and the separating wall folds along the crest forcing the sleeve portion adjacent the interior channel against and forms a seal along a door perimeter surface extending at an angle from the door stop surface.

### BACKGROUND OF THE INVENTION

### 1. Field of the Invention

The present invention relates to the field of sealing gaskets that provide a seal between two members. More particularly, the present invention relates to a sealing gasket that provides a seal between a door and body of a refrigerated railcar.

### 2. Background

Refrigerated railcars are commonly used for transporting perishable goods which require that they be kept cold or frozen. Of course, fairly large door openings are provided through the railcar body for accessing the interior thereof. The door openings are defined by a jamb whereat a door is selectively seated for closing the opening.

A rubber gasket is provided along and between the door perimeter and the jamb. The gasket is secured in place by mounting to a retainer which is, in turn, secured to the jamb or the door perimeter. When the door is closed, the gasket is compressed between the jamb and door perimeter thereby creating a seal for preventing debris, water and air from traveling through the door opening. The gasket also acts as an insulator for minimizing heat transfer through the door opening.

An exemplary prior railcar door sealing gasket is shown and described in U.S. Pat. No. 8,910,950, the disclosure of which is incorporated herein by reference. Although this and other prior railcar door sealing gaskets function fairly well in sealing debris, water and air and to minimize heat transfer, it has been found that they are not without shortcomings. Particularly, it has been found that the securement of the retainer upon which the gasket is mounted is not hermetically sealed and, hence, debris, water and air to travel therearound. Additionally, the cold air within the railcar is in direct contact with the retainer, as is the hot air outside of the railcar, and so the retainer essentially functions like a direct heat/thermal conduit between the interior and exterior of the railcar. As can be appreciated, there is a risk that the railcar contents could be contaminated by debris, water and air which may travel around the retainer and into the railcar. Additionally, air infiltration around the retainer and the retainer providing a direct thermal conduit increases the energy required to maintain the railcar interior at the desired temperature and, consequently, increases shipping costs.

Accordingly, a need exists for an improved means of sealing between a railcar door and jamb which better prevents debris, water and air from traveling therethrough and for better minimizing heat transfer therethrough.

### SUMMARY OF THE INVENTION

The present invention overcomes disadvantageous of prior railcar sealing gaskets by providing a seal between the interior and exterior of the railcar and, also, providing a seal between the interior of the railcar and the retainer upon which the gasket is mounted. By providing a seal between the interior of the railcar and the retainer, debris, water and air is prevented from traveling around the retainer. The seal between the interior of the railcar and the retainer also prevents the cold air within the railcar from coming in contact with the retainer, thereby minimizing heat transfer through the retainer. Additionally, the present invention further minimizes heat transfer from between the interior and exterior of the railcar by providing a two bulb/channel gasket wherein the bulbs/channels are filled with air and better insulate against heat transfer.

In one form thereof, the present invention is directed to a sealing gasket for sealing between a railcar body and a door at a railcar door opening wherein the door opening is defined by a door jamb and the door includes a perimeter adapted to seat on the door jamb. The sealing gasket comprises a two compartment elongate bulb body. The bulb body comprises a tubular shaped sleeve separated by an elongate wall for thereby forming an elongate exterior bulb/channel between an outer elongate wall and the separating wall and forming an elongate interior bulb/channel between an inner elongate wall and the separating wall. The bulb body is secured along one of a door jamb stop surface or a door perimeter stop surface and is compressed therebetween when the door is seated in the jamb. When the bulb body is compressed, the outer elongate wall is forced against one of the jamb stop surface or door stop surface and forms a seal therebetween, and the inner elongate wall is forced against a door perimeter surface and forms a seal therebetween.

Preferably, a retainer is provided and is secured on one of the door jamb stop surface or the door perimeter stop surface and the bulb body is mounted on the retainer. The retainer can include a pair of opposing elongate retainer channels. A base can be integrally formed with the bulb body and can comprise a pair of oppositely projecting feet. The bulb body is thereby mounted on the retainer by inserting the oppositely projecting feet in the opposing retainer channels. Also preferably, a plurality of elongate ribs can be provided protruding from an outside surface of the inner elongate wall and/or an outside surface of the outer elongate wall. The ribs extend longitudinally parallel with the sleeve. The sealing gasket elongate bulb body is preferably made of EPDM rubber.

The separating wall preferably comprises a pair of elongate planar walls extending at an angle with respect to each other. Each planar wall is integrally formed with the sleeve and with each other. The planar walls are preferably integrally formed with each other along a crest extending in a direction from the exterior elongate channel towards the interior elongate channel.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1 is an isometric view of a portion of an elongate railcar sealing gasket constructed in accordance with the principles of the present invention and adapted to be mounted on a retainer;

FIG. 2 is a side schematic view of the sealing gasket shown in FIG. 1 wherein the railcar door and jamb and the retainer are shown in cross section with the sealing gasket mounted on the retainer, and wherein the sealing gasket is shown in an uncompressed state where the railcar door is open; and,

FIG. 3 is a side schematic view similar to FIG. 2 but wherein the railcar door is shown in its closed position and showing the sealing gasket in its compressed state wherein a seal is provided between the sealing gasket and the jamb stop surface and a seal is also provided between the sealing gasket and the door interior perimeter surface.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

Referring to the drawings, a sealing gasket constructed in accordance with the principles of the present invention is shown and generally designated by the numeral 10. As more fully described herein below, sealing gasket 10 is elongate and is located and is adapted to provide a seal between a refrigerated railcar body 12 and a door 14 at a railcar door opening 16.

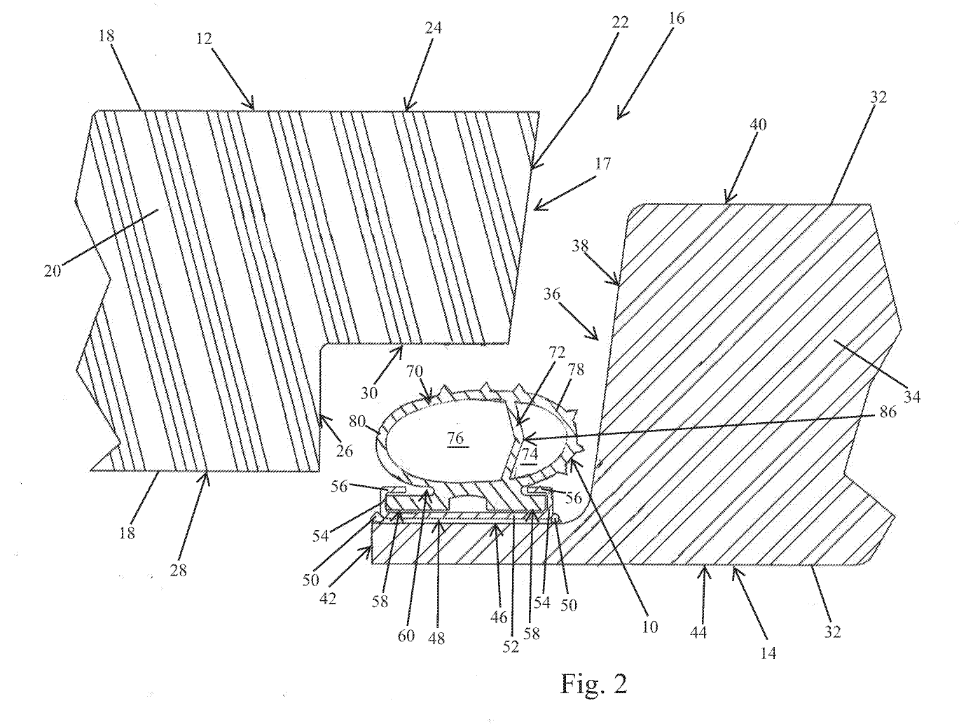

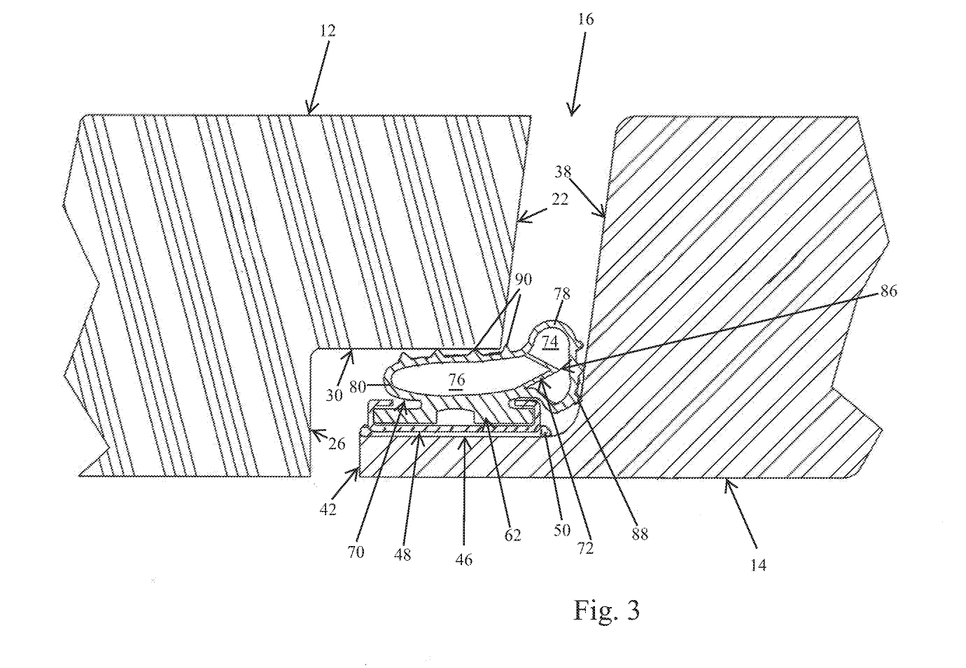

As shown in FIGS. 2 and 3, the walls of the railcar body 12 are typically constructed having an outer steel skin 18 encapsulating insulation material 20. The railcar door opening 16 is defined by jamb 17 including an interior jamb surface 22 projecting outwardly from the railcar interior surface 24, an exterior jamb surface 26 projecting inwardly from the railcar exterior surface 28, and a jamb stop surface 30 between and adjoining the jamb interior and exterior surfaces 26, 28. The interior jamb surface 22, jamb stop surface 30 and exterior jamb surface 26 are typically also made of steel. The stop surface 30 is typically parallel with the railcar interior and exterior surfaces 24, 28.

The railcar door 14 is hinged in a known and customary manner to the railcar body 12 (not shown) and is adapted to swing between an open position as depicted in FIG. 2 and a closed position as shown in FIG. 3. Alternatively, door 14 can be a plug door adapted to roll on tracks and be cantilevered in a known and customary manner on the railcar body 12 (not shown) over and to the side of the opening 16 between an open position as depicted in FIG. 2 and a closed/seated position as shown in FIG. 3.

Door 14 is typically constructed similar to the railcar body 12, having an exterior steel skin 32 encapsulating insulation material 34. Door 14 is defined by a perimeter edge 36 adapted to be received within and abut the jamb 17. More particularly, the door perimeter edge 36 includes an interior perimeter surface 38 projecting outwardly from the door interior surface 40, an exterior perimeter surface 42 projecting inwardly from the door exterior surface 44, and a door perimeter stop surface 46 between and adjoining the perimeter interior surface 38 and perimeter exterior surface 42. The door interior perimeter surface 38, perimeter stop surface 46 and exterior perimeter surface 42 are also typically made of steel. The door perimeter stop surface 46 is typically parallel with the door interior and exterior surfaces 40, 44.

As should now be appreciated and as shown in FIG. 3, when door 14 is in its closed/seated position, sealing gasket 10 is located and is sandwiched between the railcar door jamb 17 and the door perimeter edge 36. More particularly, the sealing gasket 10 is located and is compressively sandwiched between the jamb stop surface 30 and the door perimeter stop surface 46.

Sealing gasket 10 is preferably secured to the door 14 and extends along the entire door perimeter stop surface 46 as shown, although it can, instead, be secured to the jamb 17 extending along the entire jamb stop surface 30. In this regard, an elongate steel gasket retainer 48 is provided for attaching the sealing gasket 10. The gasket retainer 48 is secured to the door perimeter stop surface 46 with fasteners (not shown) and/or by welding 50 in a known and customary manner. The sealing gasket 10 is, in turn, mounted on the gasket retainer 48 as described herein below.

The elongate gasket retainer 48 is generally U-shaped in cross section and includes a central flat portion 52 and upstanding legs 54 extending upwardly therefrom. A rim 56 is provided along each upper terminal edge of the legs 54 extending back towards the central flat portion 52. Opposing elongate retainer channels 58 are thereby defined on each side of the gasket retainer by the rim 56, leg 54 and central portion 52. An elongate retainer opening 60 is thereby also defined between the rims 56 leading to the channels 58.

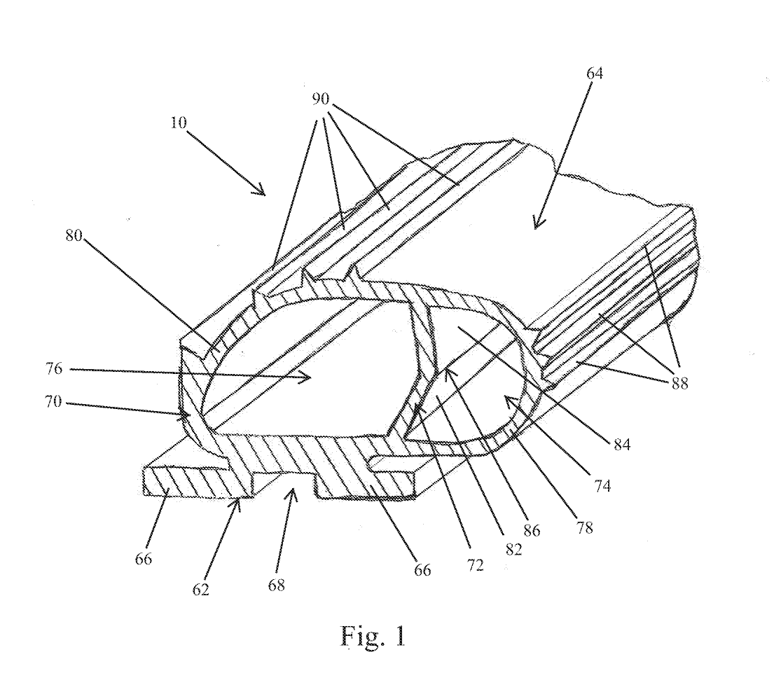

Referring now more particularly to FIG. 1, the elongate sealing gasket 10, as seen in cross section, includes a base 62 and a two compartment bulb body 64 which are integrally formed, typically by extrusion. Sealing gasket 10 is preferably made of EPDM (ethylene propylene diene monomer) organic rubber having a generally soft 50 durometer on the A scale.

The base 62 includes a pair of oppositely projecting feet 66 separated by a center groove 68. As shown in FIGS. 2 and 3, the sealing gasket 10 is secured and held firmly on the retainer 48 by inserting the feet 66 through the retainer opening 60 and then inserting them within the opposing retainer channels 58.

The two compartment bulb body 64 comprises a tubular shaped sleeve 70 longitudinally separated by an integrally formed wall 72, thereby forming an interior elongate channel 74 and an exterior elongate channel 76. The interior channel 74 is, hence, defined by an inner elongate wall 78 and the separating wall 72. The exterior channel 76 is, hence, defined by an outer elongate wall 80 and the separating wall 72. The sleeve 70 is preferably also integrally formed with and is thereby attached to the base 62.

The separating wall 72 preferably comprises a pair of elongate planar walls 82, 84. Walls 82, 84 are not coplanar and extend at an angle with respect to each other from the inner surface of the sleeve 70 to a central elongate crease/crest 86. Separating wall 72 is thereby arrow shaped as seen in cross section and forming the crest 86 which extends in a direction from the exterior elongate channel 76 towards the interior elongate channel 74.

Elongate ribs 88, 90 are provided on and protrude outwardly from the outer surface of the sleeve 70, and extend longitudinally parallel therewith. More particularly, the elongate ribs 88 are provided on the outside surface of the inner elongate wall 78, and the elongate ribs 90 are provided on the outside surface of the outer elongate wall 80.

In use, when the door 14 is in its open position as depicted in FIG. 2, the sealing gasket 10 is relaxed taking a shape generally as originally formed during the extrusion process. However, when compressed between the jamb stop surface 30 and the door stop surface 46 as shown in FIG. 3, the jamb stop surface 30 pushes against the outer elongate wall 80 thereby compressing the exterior elongate channel 76 and causing the separating wall 72 to fold/bend along the crease/crest 86 and extend towards the interior elongate channel 74. This causes the walls 82, 84 and the crest 86 to project towards the interior elongate channel 74 as diagrammatically depicted in FIG. 3 pushing the inner elongate wall 78 towards and against the door interior perimeter surface 38. Hence, when sealing gasket 10 is in its compressed state, the outer elongate wall 80 and/or ribs 90 thereof are forced against the jamb stop surface 30 and forms a seal therebetween, whereas the inner elongate wall 78 and/or ribs 88 thereof is forced against the door interior perimeter wall surface 38 and forms a seal therebetween.

As should now be appreciated, the seal between the outer elongate wall 80 and/or ribs 90 thereof and the jamb stop surface 30 seals out water, air and debris from traveling through the door opening 16. The seal between the inner elongate wall 78 and/or ribs 88 thereof and the door interior perimeter wall surface 38 seals against water, air and debris from traveling between the sealing gasket 10 and the door 14. More particularly, because the securement between the sealing gasket base 62 and the retainer 48 and the securement between the retainer 48 and the door stop surface 46 are not hermetically sealed, the seal between the inner elongate wall 78 and/or ribs 88 thereof and the door interior perimeter wall surface 38 seals against water, air and debris from traveling around the retainer 48 between the interior and exterior of the railcar body 12. Additionally, the two compartment bulb body 64 functions to provide a better thermal insulating barrier between the interior and exterior of the railcar body 12. In this regard, as should be appreciated by one skilled in the art, the separate interior and exterior elongate air filled channels 74, 76 provide two separate thermal resistive barriers which are superior to the prior art single bulb/channel gaskets.

While this invention has been described as having an exemplary design, the present invention may be further modified within the spirit and scope of this disclosure. This application is therefore intended to cover any variations, uses, or adaptations of the invention using its general principles.

What is claimed is:

1. A sealing gasket for sealing between a railcar body and a door at a railcar door opening wherein the door opening is defined by a door jamb and the door includes a perimeter adapted to seat on the door jamb, said sealing gasket comprising:
a two compartment elongate bulb body, wherein said body comprises a tubular shaped sleeve separated by an elongate wall thereby forming an elongate exterior channel between an outer elongate wall and the separating wall and forming an elongate interior channel between an inner elongate wall and the separating wall;
wherein said bulb body is secured along one of a door jamb stop surface or a door perimeter stop surface and is compressed therebetween when the door is seated in the jamb; and,
wherein, when said bulb body is compressed, said outer elongate wall is forced against one of the jamb stop surface or door stop surface and forms a seal therebetween and said inner elongate wall is forced against a door perimeter surface and forms a seal therebetween.

2. The sealing gasket of claim 1 wherein a retainer is secured on one of said door jamb stop surface or said door perimeter stop surface and said bulb body is mounted on the retainer.

3. The sealing gasket of claim 2 wherein the retainer includes a pair of opposing elongate retainer channels and wherein a base comprising a pair of oppositely projecting feet is integrally formed with said bulb body, and wherein said bulb body is mounted on the retainer by inserting said oppositely projecting feet in the opposing retainer channels.

4. The sealing gasket of claim 1 further comprising a plurality of elongate ribs protruding from an outside surface of said inner elongate wall and extending longitudinally parallel with said sleeve.

5. The sealing gasket of claim 1 further comprising a plurality of elongate ribs protruding from an outside surface of said outer elongate wall and extending longitudinally parallel with said sleeve.

6. The sealing gasket of claim 1 further comprising a plurality of elongate ribs protruding from an outside surface of said sleeve and extending longitudinally parallel therewith.

7. The sealing gasket of claim 1 wherein said elongate bulb body is made of EPDM rubber.

8. The sealing gasket of claim 1 wherein said separating wall comprises a pair of elongate planar walls extending at an angle with respect to each other, each planar wall integrally formed with said sleeve and with each other.

9. The sealing gasket of claim 8 wherein a retainer is secured on one of said door jamb stop surface or said door perimeter stop surface and said bulb body is mounted on the retainer.

10. The sealing gasket of claim 9 wherein the retainer includes a pair of opposing elongate retainer channels and wherein a base comprising a pair of oppositely projecting feet is integrally formed with said bulb body, and wherein said bulb body is mounted on the retainer by inserting said oppositely projecting feet in the opposing retainer channels.

11. The sealing gasket of claim 8 further comprising a plurality of elongate ribs protruding from an outside surface of said inner elongate wall and extending longitudinally parallel with said sleeve.

12. The sealing gasket of claim 8 further comprising a plurality of elongate ribs protruding from an outside surface of said outer elongate wall and extending longitudinally parallel with said sleeve.

13. The sealing gasket of claim 8 further comprising a plurality of elongate ribs protruding from an outside surface of said sleeve and extending longitudinally parallel therewith.

14. The sealing gasket of claim 8 wherein said elongate bulb body is made of EPDM rubber.

15. The sealing gasket of claim 8 wherein said planar walls are integrally formed with each other along a crest extending in a direction from said exterior elongate channel towards said interior elongate channel.

16. The sealing gasket of claim 15 wherein a retainer is secured on one of said door jamb stop surface or said door perimeter stop surface and said bulb body is mounted on the retainer.

17. The sealing gasket of claim 15 wherein the retainer includes a pair of opposing elongate retainer channels and wherein a base comprising a pair of oppositely projecting feet is integrally formed with said bulb body, and wherein said bulb body is mounted on the retainer by inserting said oppositely projecting feet in the opposing retainer channels.

18. The sealing gasket of claim 15 further comprising a plurality of elongate ribs protruding from an outside surface of said sleeve and extending longitudinally parallel therewith.

19. The sealing gasket of claim 15 wherein said elongate bulb body is made of EPDM rubber.

20. A sealing gasket for sealing between a railcar body and a door at a railcar door opening wherein the door opening is defined by a door jamb and the door includes a perimeter adapted to seat on the door jamb, said sealing gasket comprising:
a two compartment elongate bulb body, wherein said body comprises a tubular shaped sleeve separated by an elongate wall thereby forming an elongate exterior channel between an outer elongate wall and the separating wall and forming an elongate interior channel between an inner elongate wall and the separating wall;
wherein said bulb body is secured along one of a door jamb stop surface or a door perimeter stop surface and is compressed therebetween when the door is seated in the jamb;
wherein, when said bulb body is compressed, said outer elongate wall is forced against one of the jamb stop surface or door stop surface and forms a seal therebetween and said inner elongate wall is forced against a door perimeter surface and forms a seal therebetween;
wherein said separating wall comprises a pair of elongate planar walls extending at an angle with respect to each other, each planar wall integrally formed with said sleeve and with each other;
wherein said planar walls are integrally formed with each other along a crest extending in a direction from said exterior elongate channel towards said interior elongate channel;
wherein a retainer is secured on one of said door jamb stop surface or said door perimeter stop surface and said bulb body is mounted on the retainer;
wherein the retainer includes a pair of opposing elongate retainer channels and wherein a base comprising a pair of oppositely projecting feet is integrally formed with said bulb body, and wherein said bulb body is mounted on the retainer by inserting said oppositely projecting feet in the opposing retainer channels;
a plurality of elongate ribs protruding from an outside surface of said sleeve and extending longitudinally parallel therewith; and,
wherein said elongate bulb body is made of EPDM rubber.
